(19) United States
(12) Patent Application Publication
(10) Pub. No.: US 2008/0285000 A1
(43) Pub. Date: Nov. 20, 2008

(54) Lithographic apparatus and device manufacturing method

(75) Inventors: Hendrikus Alphonsus Ludovicus Van Dijck, Ijsselstein (NL); Freerk Adriaan Stoffels, Veldhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/798,932

(22) Filed: May 17, 2007

(51) Int. Cl. G03B 27/42

(52) U.S. Cl. 355/67; 355/77

(57) ABSTRACT

A lithographic apparatus includes a projection system configured to project a patterned radiation beam onto a target portion of a substrate. The apparatus is configured to provide the radiation beam with a radiation distribution in a pupil plane of an illumination system of the apparatus, the intensity of the radiation contained substantially within a plurality of discrete areas across the radiation beam and the radiation beam having one or more first regions of a first polarization having a spatial distribution across the pupil plane which overlap partial portions of the discrete areas and one or more second regions of a second polarization having a spatial distribution in areas across the pupil plane which overlap the rest of the discrete areas other than the partial portions. The apparatus further includes a polarization filter, in the radiation beam path between at least part of the projection system and the substrate, configured to selectively transmit parts of the radiation beam having a polarization of only one of said first and second polarizations, such that only radiation corresponding to either said partial portions or said rest of the discrete areas is incident on the target portion of the substrate.

### FIELD

The present invention relates to a lithographic apparatus and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It is well-known in the art of lithography that the image of, for example, a mask pattern can be improved, and process windows enlarged, by appropriate choice of the angles at which the mask pattern is illuminated. In an apparatus having a Koehler illumination arrangement, the angular distribution of radiation illuminating the mask is determined by the intensity distribution in a pupil plane of the illumination system, which can be regarded as a secondary source. Illumination modes are commonly described by reference to the shape of the intensity distribution in the pupil plane. Conventional illumination, i.e. even illumination from all angles from 0 to a certain maximum angle, involves a uniform disk-shaped intensity distribution in the pupil plane. Other commonly-used intensity distributions are: annular, in which the intensity distribution in the pupil plane is an annulus; dipole illumination, in which there are two poles in the pupil plane; and quadrupole illumination, in which there are four poles in the pupil plane. To create these illumination schemes, various methods have been proposed. For example, a zoom-axicon, that is a combination of a zoom lens and an axicon, can be used to create annular illumination with controllable inner and outer radii (σᵢₙₙₑᵣ and σₒᵤₜₑᵣ) of the annulus. To create dipole and quadrupole type illumination modes, it has been proposed to use spatial filters, that is opaque plates with apertures where the poles are desired as well as arrangements using moveable bundles of optical fibers. Using spatial filters is undesirable because the resulting loss of radiation reduces the throughput of the apparatus and hence increases its cost of ownership. Arrangements with bundles of optical fibers are complex and inflexible. It has therefore been proposed to use diffractive optical elements (DOEs) to form the desired intensity distribution in the pupil plane. See, for example, European patent applications EP 0 949 541 A and EP 1 109 067 A. These documents describe, inter alia, diffractive optical elements in which different regions may have different effects, e.g. forming quadrupole or conventional illumination modes so that mixed or “soft” illumination modes can be created. The diffractive optical elements are made by etching different patterns into different parts of the surface of a quartz or CaF₂ substrate. European patent application EP 1 367 446 A discloses a method of making a custom DOE from a set of small pieces.

The choice of materials from which optical elements, such as lenses, useable with ultraviolet radiation, e.g. at 198 nm, 157 nm or 126 nm, can be made is quite limited and even the best materials have significant coefficients of absorption of this radiation. This means that, for example, the lenses in the projection system absorb energy during exposures and heat up, leading to changes in their shape, separation and refractive index which introduce aberrations into the projected image. Therefore many optical systems are provided with one or more actuated lens elements whose shape, position and/or orientation in one or more degrees of freedom can be adjusted during or between exposures to compensate for such heating effects.

If an illumination mode, such as dipole, in which the energy of the projection beam is strongly localized in the pupil plane of the illumination system is used, then the energy of the projection beam will also be strongly localized in and near the pupil plane(s) of the projection system. Heating effects are more severe when such localized illumination modes are used because the temperature gradients in the optical elements affected are greater, leading to localized changes in shape and/or refractive index which cause large phase gradients in the projection beam. These effects are often not correctable by existing actuated lens elements, which generally effect corrections described by only lower order Zernike polynomials e.g. up to Z5 or Z6. Similar effects can be caused by the use of a slit-shaped illumination field, as is common in scanning lithographic apparatus, but these effects are generally of lower order, and more easily correctable. The same effects can also be observed in mirrors with less than 100% reflectivity in catadioptric and reflective projection systems.

A past attempt to deal with the problem of such non-uniform heating includes the provision of additional radiation sources, e.g. infra-red, to heat the “cold” parts, i.e. those not traversed by the intense parts of the projection beam, of elements of the projection system. See U.S. Pat. No. 6,504,597 and Japanese patent application publication JP-A-08-22126.1. The former of these documents addresses non-uniform heating caused by a slit-shaped illumination field and the latter non-uniform heating caused by zonal or modified illumination. The provision of such additional radiation sources and guides to conduct the additional heating radiation to the correct places increases the complexity of the apparatus and the increased heat load in the projection system necessitates the provision of a cooling system of higher capacity.

Another proposal to deal with non-uniform heating caused by a slit-shaped illumination field is disclosed in U.S. Pat. No. 6,603,530. This document describes a special “lens illumination mark” provided in the reticle stage outside of the reticle area which diverges radiation so that the illumination of the lens elements in the projection system is rotationally symmetric. The lens elements are thermally saturated by illumination through the special mark before production exposures so that the non-rotationally symmetric heating caused by a slit-shaped illumination system does not cause non-rotationally symmetric aberrations.

The problem of non-uniform heating caused by localized illumination modes is addressed in PCT patent application publication WO 2004/051716. In one proposal described in this document, “dummy irradiation” is performed during substrate exchange to heat the cold parts of the lens elements affected by non-uniform heating in production exposures. During the dummy irradiation, the illumination mode is set, using a diffractive optical element or an adjustable diaphragm, to be the inverse of the illumination mode used for production exposures so that the heating effects of the dummy irradiation are the inverse of the heating effects of production exposures and the net heating is more uniform. Another proposal of this document is to use additional infra-red radiation to locally heat selected lens elements.

### SUMMARY

It is desirable to provide an improved method for at least reducing or mitigating for the effects of non-uniform heating of elements of a projection system when using localized illumination modes.

According to an aspect of the invention, there is provided a lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate table constructed to hold a substrate; and
a projection system configured to project the patterned radiation beam onto a target portion of the substrate,
wherein the apparatus is configured to provide the radiation beam with a radiation distribution in a pupil plane of the illumination system, the intensity of the radiation contained substantially within a plurality of discrete areas across the beam and the radiation beam having one or more first regions of a first polarization having a spatial distribution across the pupil plane which overlap partial portions of the discrete areas and one or more second regions of a second polarization having a spatial distribution in areas across the pupil plane which overlap the rest of the discrete areas other than the partial portions, and
wherein the apparatus further comprises a polarization filter, in the beam path between at least part of the projection system and the substrate, configured to selectively transmit parts of the radiation beam having a polarization of only one of said first and second polarizations, such that only radiation corresponding, to either said partial portions or said rest of the discrete areas is incident on the target portion of the substrate.

According to an aspect of the invention, there is provided a device manufacturing method, comprising:
projecting a patterned radiation beam toward a target portion of a substrate using a projection system having a pupil plane, the radiation beam having a radiation distribution in the pupil plane wherein the intensity of the radiation is contained substantially within a plurality of discrete areas across the radiation beam and the radiation beam has one or more first regions of a first polarization having a spatial distribution across the pupil plane which overlap partial portions of the discrete areas and one or more second regions of a second polarization having a spatial distribution in areas across the pupil plane which overlap the rest of the discrete areas other than the partial portions; and
selectively transmitting parts of the radiation beam having a polarization of only one of said first and second polarizations, such that only radiation corresponding to either said partial portions or said rest of the discrete areas is incident on the target portion of the substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 is a schematic illustration of an optical arrangement which may be incorporated in the apparatus of FIG. 1;

FIG. 3 depicts a dipole illumination mode;

FIG. 4 depicts a modification of the optical arrangement shown in FIG. 2 in accordance with an embodiment of the invention;

FIG. 5 depicts an illumination mode produced by the optical arrangement of FIG. 4;

FIG. 6 illustrates the polarization mode produced by the polarizer in the optical arrangement of FIG. 4; and

FIG. 7 illustrates the illumination distribution produced by the optical arrangement of FIG. 4.

### DETAILED DESCRIPTION

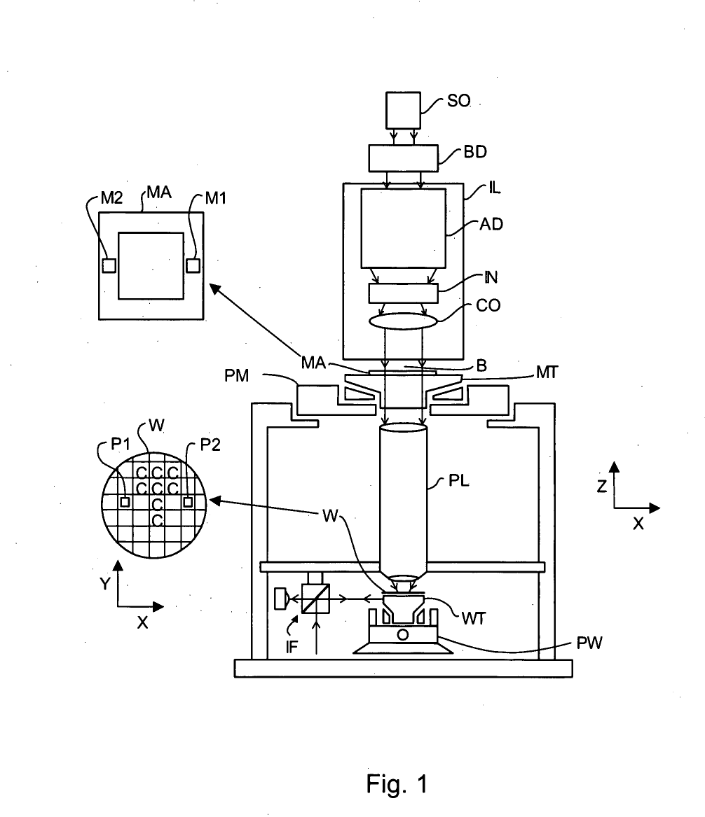

FIG. 1 schematically depicts a lithographic apparatus according to one embodiment of the invention. The apparatus comprises:

an illumination system (illuminator) IL configured to condition a radiation beam B (e.g. UV radiation or DUV radiation);

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PL configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PL, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

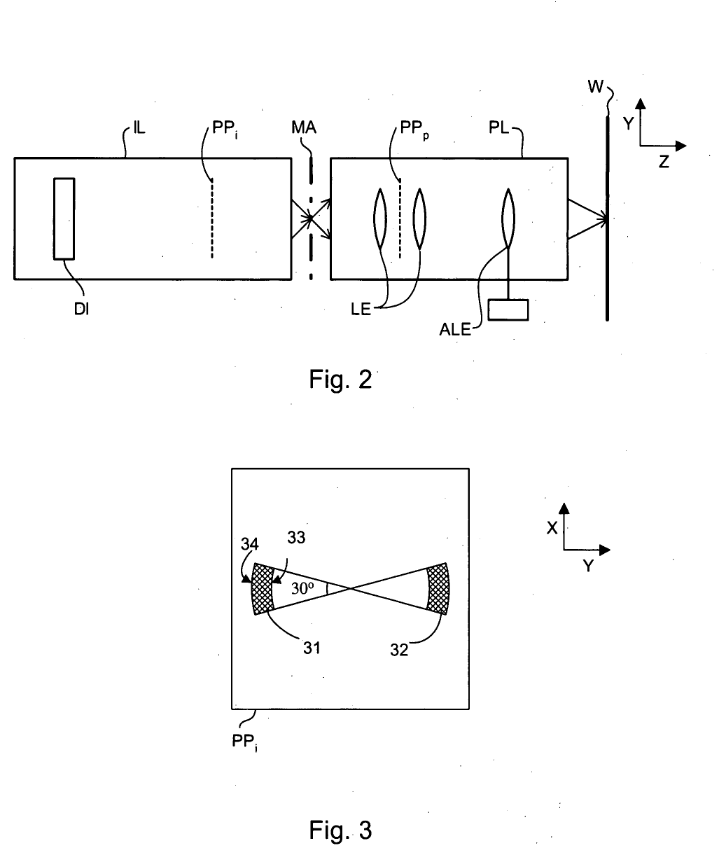

FIG. 2 is a schematic illustration, in the Y-Z plane of an optical arrangement which may be incorporated in the apparatus of FIG. 1. The optical arrangement uses Koehler illumination where a pupil plane PPᵢ in the illumination system IL is a Fourier transform plane of the object plane in which the patterning device MA is located and is conjugate to a pupil plane PPₚ of the projection system PL. As is conventional, illumination modes of this apparatus produced by the dipole illumination element, shown schematically as DI, can be described by reference to the distribution of intensity of the radiation of the projection beam in the pupil plane PPᵢ of the illumination system. It will be understood that the distribution of intensity in the pupil plane PPₚ of the projection system PL will be the same as the distribution of intensity in the pupil plane PPᵢ of the illumination system IL, subject to diffraction effects produced by the pattern created by the patterning device MA.

For a pattern consisting essentially of lines in one direction, good imaging and a large process window can be obtained by use of dipole illumination in which the poles are arranged such that in the pupil plane PPₚ of the projection system, one of the first order diffracted beams deriving from each of the two poles in the illumination system coincides with the zeroth order beam deriving from the other pole. The other first order beams and higher order beams are not captured by the projection system PL.

A form of the dipole arrangement produced at the pupil plane PPᵢ in the illumination system IL is shown in FIG. 3. The two poles 31, 32 take the form of segments of an annulus subtending an angle of about 30° with the inner radius 33 defining the inner radial extent of the beam, σ-inner, and outer radius 34 defining the outer radial extent of the beam, σ-outer. This intensity distribution is convenient as it provides good imaging and is easy to create using a diffractive optical element and a zoom axicon. However such an intensity distribution may give rise to aberrations caused by non-uniform heating of optical elements LE, such as lens elements, in or adjacent to the pupil plane PPP in the projection system PL that are not correctable by known adjustable optical elements, one example of which is shown as ALE. Heating effects caused by an intensity distribution comprising dipoles that are annular but subtend a larger angle, e.g. 90°, are acceptable or correctable by known adjustable optical elements ALE. In other respects however, such an intensity distribution provides inferior imaging performance as a larger proportion of the first diffraction orders fall outside the pupil, leading to lower image contrast.

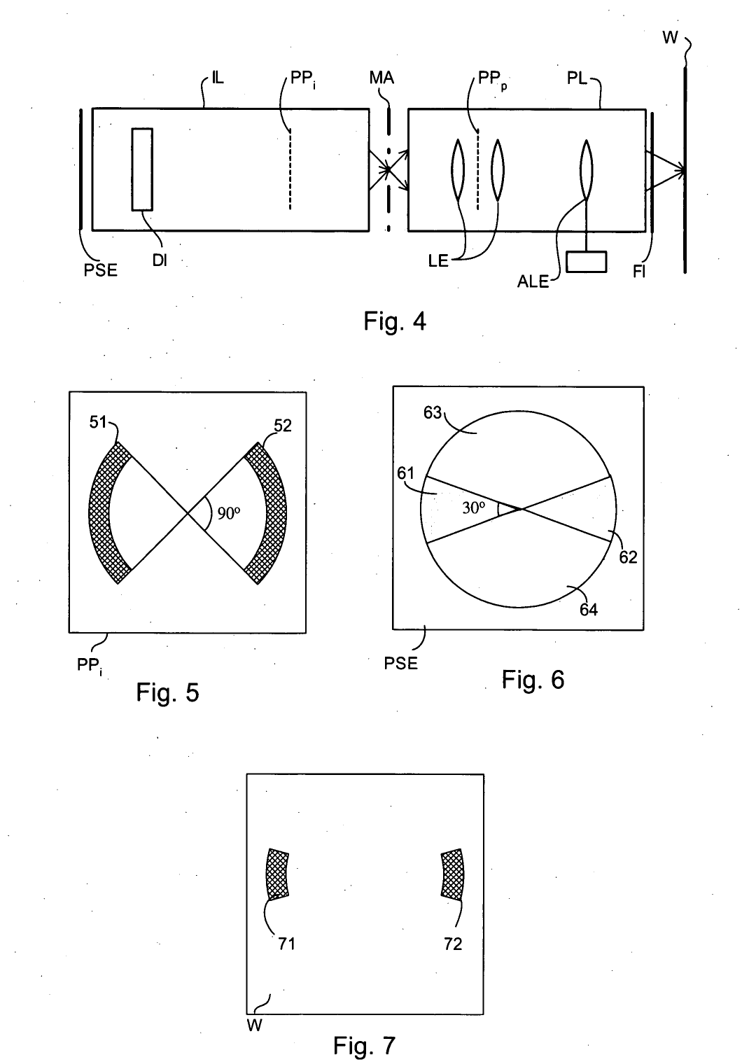

Turning now to FIG. 4, in accordance with an embodiment of the invention in order to reduce or mitigate the effects of heating using a dipole setting with a narrow opening angle such as 30°, a lithographic apparatus in accordance with an embodiment of the invention is arranged to produce dipole illumination using a larger opening angle, such as 90°, but with the radiation within the 30° opening angle having a particular polarization mode and the rest of the radiation within the 90° opening angle having a different polarization mode. The radiation of the different polarization mode is then filtered out at or near the end of the projection system PL such that the radiation projected onto the substrate W is restricted to radiation from the 30° opening angle.

FIG. 5 illustrates the dipole illumination produced at the pupil plane PPᵢ of the optical arrangement shown in FIG. 4. As can be seen from FIG. 5 the two annular poles 51, 52 each have an opening angle of 90°. A polarizing shaping element, indicated as item PSE is shown at the entrance to the illumination system IL in FIG. 4, although it will be appreciated that it can be incorporated anywhere within the illumination system. The polarizing shaping element PSE is arranged such that, as shown in FIG. 6 which depicts the spatial distribution of the polarization state across the beam in the X-Y plane, radiation within a 30° opening angle has a vertical polarization in regions 61 and 62, that is in the Z direction, while the radiation in the remaining regions 63, 64 has a polarization within the X-Y plane.

A selectable polarization filter F1 is placed at the end of the projection system PL as indicated in FIG. 4. This filter F1 is arranged only to let radiation with a vertical polarization pass. This results in the illumination pattern indicated in FIG. 7 on the substrate W. Thus the illumination pattern has two patches of illumination 71, 72 which correspond to the spatial distribution which would have been produced by a conventional dipole source such as indicated in FIG. 3, whilst reducing or avoiding problems of heating of the elements LE and ALE which would have occurred by use of such a conventional dipole source.

It will be appreciated that it will not be possible in all cases to eliminate entirely aberrations induced by such heating, either by an apparatus or method in accordance with an embodiment of the invention or with other available adjustable optical elements. Thus, in general, the combination of an illumination source having a large opening angle and a polarizing arrangement for restricting the opening angle of the radiation projected on the substrate W, should be arranged, in combination with other available adjustable elements and subject to other constraints, to minimize pupil deformations in the parts of the pupil that are significant for imaging. On the other hand, where deformations of the pupil plane can be well corrected, e.g. using a 2-dimensional pupil phase manipulator, an embodiment of the invention may be used to also minimize field variations.

It will be appreciated that whilst in the embodiment described above, a dipole illumination mode having a 30° opening angle is produced from a dipole illumination source producing dipole illumination having a 90° opening angle, any suitable angles may be chosen, subject to the wide angle not producing significant or non-correctable heating which induces aberrations. It will also be appreciated that the invention is applicable to other intensity distributions, for example quadrupole illumination with a suitable polarization distribution. It will also be appreciated that whilst the use of four discrete areas of two different polarizations is particularly appropriate for a dipole illumination arrangement, the regions of the same polarization may be merged, subject to the combination of the polarization and the polarization filter being effective to reduce the opening angles of the radiation projected onto the substrate.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate table constructed to hold a substrate; and
a projection system configured to project the patterned radiation beam onto a target portion of the substrate,
wherein the apparatus is configured to provide the radiation beam with a radiation distribution in a pupil plane of the illumination system, the intensity of the radiation contained substantially within a plurality of discrete areas across the radiation beam and the radiation beam having one or more first regions of a first polarization having a spatial distribution across the pupil plane which overlap partial portions of the discrete areas and one or more second regions of a second polarization having a spatial distribution in areas across the pupil plane which overlap the rest of the discrete areas other than the partial portions, and
wherein the apparatus further comprises a polarization filter, in or arrangeable into the radiation beam path between at least part of the projection system and the substrate, configured to selectively transmit parts of the radiation beam having a polarization of only one of said first and second polarizations, such that only radiation corresponding to either said partial portions or said rest of the discrete areas is incident on the target portion of the substrate.

2. A lithographic apparatus according to claim 1, wherein the radiation distribution is a dipole distribution.

3. A lithographic apparatus according to claim 2, wherein the dipole distribution has an opening angle of substantially 90°.

4. A lithographic apparatus according to claim 2, wherein the one or more first regions of the first polarization are opposing segments of a circular spatial distribution, the segments having an opening angle of substantially 30°.

5. A lithographic apparatus according to claim 2, wherein the poles of the dipole distribution are annular segments and the one or more first and second regions are circular segments of a circular spatial distribution aligned with the annular segments.

6. A device manufacturing method, comprising:
projecting a patterned radiation beam toward a target portion of a substrate using a projection system having a pupil plane, the radiation beam having a radiation distribution in the pupil plane wherein the intensity of the radiation is contained substantially within a plurality of discrete areas across the radiation beam and the radiation beam has one or more first regions of a first polarization having a spatial distribution across the pupil plane which overlap partial portions of the discrete areas and one or more second regions of a second polarization having a spatial distribution in areas across the pupil plane which overlap the rest of the discrete areas other than the partial portions; and
selectively transmitting parts of the radiation beam having a polarization of only one of said first and second polarizations, such that only radiation corresponding to either said partial portions or said rest of the discrete areas is incident on the target portion of the substrate.

7. A method according to claim 6, wherein the radiation distribution is a dipole distribution.

8. A method according to claim 7, wherein the dipole distribution has an opening angle of substantially 90°.

9. A method according to claim 7, wherein the one or more first regions of the first polarization are opposing segments of a circular spatial distribution, the segments having an opening angle of substantially 30°.

10. A method according to claim 7, wherein the poles of the dipole distribution are annular segments and the one or more first and second regions are circular segments of a circular spatial distribution aligned with the annular segments.

11. A data storage medium having stored therein a computer program containing one or more sequences of machine-readable instructions to cause a lithographic apparatus to perform a method comprising:
projecting a patterned radiation beam toward a target portion of a substrate using a projection system having a pupil plane, the radiation beam having a radiation distribution in the pupil plane wherein the intensity of the radiation is contained substantially within a plurality of discrete areas across the radiation beam and the radiation beam has one or more first regions of a first polarization having a spatial distribution across the pupil plane which overlap partial portions of the discrete areas and one or more second regions of a second polarization having a spatial distribution in areas across the pupil plane which overlap the rest of the discrete areas other than the partial portions; and
selectively transmitting parts of the radiation beam having a polarization of only one of said first and second polarizations, such that only radiation corresponding to either said partial portions or said rest of the discrete areas is incident on the target portion of the substrate.

12. A data storage medium according to claim 11, wherein the radiation distribution is a dipole distribution

13. A data storage medium according to claim 12, wherein the dipole distribution has an opening angle of substantially 90°.

14. A data storage medium according to claim 12, wherein the one or more first regions of the first polarization are opposing segments of a circular spatial distribution, the segments having an opening angle of substantially 30+.

15. A data storage medium according to claim 12, wherein the poles of the dipole distribution are annular segments and the one or more first and second regions are circular segments of a circular spatial distribution aligned with the annular segments.
